(19) United States
(12) Patent Application Publication
(10) Pub. No.: US 2012/0124500 A1
(43) Pub. Date: May 17, 2012

(54) USE OF DISCRETE INPUT TO CONTROL CONTROLLABLE DEVICE

(75) Inventor: Jim Hunter, Sunnyvale, CA (US)

(73) Assignee: MOTOROLA MOBILITY, INC., Libertyville, IL (US)

(21) Appl. No.: 13/277,254

(22) Filed: Oct. 20, 2011

Related U.S. Application Data
(60) Provisional application No. 61/414,212, filed on Nov. 16, 2010.

(51) Int. Cl. G06F 3/048

(52) U.S. Cl. 715/767

(57) ABSTRACT

In one embodiment, a method includes determining focus on a focus item associated with a controllable item. The focus item is displayed on an interface used to automatically control the controllable item. A controllable attribute is determined for controlling the controllable item. The controllable attribute is controllable by a first input device using incremental inputs. The method outputs an interface control on the interface for the controllable attribute. The interface control is configured to receive a discrete value from a second input device where the second input device is configured to transmit the discrete value. The discrete value is received from the second input device and the method causes automatic control of the controllable item to adjust the controllable attribute of the controllable item from a current value to the discrete value based on receiving the discrete value.

### CROSS REFERENCE TO RELATED APPLICATIONS

The present application claims priority to U.S. Provisional App. No. 61/414,212 for “Numeric Input Directed to Controllable Device” filed Nov. 16, 2010, the contents of which is incorporated herein by reference in their entirety.

### BACKGROUND

Particular embodiments generally relate to item control.

Controllable items include dedicated input devices that are provided by manufacturers of the controllable items. For example, attributes of the controllable items may be controlled by the input device, such as the brightness of a light or the temperature of a thermostat may be increased or decreased. In some examples, the input device is integrated with the controllable item (i.e., the input device is not “remote”). Manufacturers may minimize the size of the input device because of the integration. For example, including a larger integrated input device may take valuable space on the controllable item. Because of the space limitation, controls on the input device may be limited in functionality. Also, even if an input device is a remote input device, functionality may be limited because of cost or other reasons. In one example, input devices may be limited to changing an attribute in small consecutive increments using incremental controls. The incremental controls are simple to use and require minimal space. For example, the user may be limited to “up” or “down” controls (e.g., arrow keys or a slider control). In one example, a user may increase the brightness of a lamp one incremental level at a time or the temperature of a thermostat may be increased one degree at a time. When big changes in the attribute need to be made, incrementally changing the controllable attribute may be tedious. For example, changing the brightness of a lamp from 50% to 60% may require ten inputs.

Other devices may have input devices that have a numeric keypad. For example, a television may have an input device that allows a channel number to be directly input. The set top box may then jump to that channel input. However, the functionality to receive the numeric input from the manufacturer's input device is created and installed by the manufacturer of the controllable item.

### SUMMARY

In one embodiment, a method includes determining focus on a focus item associated with a controllable item. The focus item is displayed on an interface used to automatically control the controllable item. A controllable attribute is determined for controlling the controllable item. The controllable attribute is controllable by a first input device using incremental inputs. The method outputs an interface control on the interface for the controllable attribute. The interface control is configured to receive a discrete value from a second input device where the second input device is configured to transmit the discrete value. The discrete value is received from the second input device and the method causes automatic control of the controllable item to adjust the controllable attribute of the controllable item from a current value to the discrete value based on receiving the discrete value.

In one embodiment, a non-transitory computer-readable storage medium is provided containing instructions for controlling a computer system to be operable to: determine focus on a focus item associated with a controllable item, the focus item being displayed on an interface used to automatically control the controllable item; determine a controllable attribute for controlling the controllable item, the controllable attribute being controllable by a first input device using incremental inputs; output an interface control on the interface for the controllable attribute, the interface control configured to receive a discrete value from a second input device, the second input device configured to transmit the discrete value; receive the discrete value from the second input device; and cause automatic control of the controllable item to adjust the controllable attribute of the controllable item from a current value to the discrete value based on receiving the discrete value.

In one embodiment, an apparatus includes one or more computer processors and a computer-readable storage medium. The computer-readable storage medium comprises instructions for controlling the one or more computer processors to be operable to: determine focus on a focus item associated with a controllable item, the focus item being displayed on an interface used to automatically control the controllable item; determine a controllable attribute for controlling the controllable item, the controllable attribute being controllable by a first input device using incremental inputs; output an interface control on the interface for the controllable attribute, the interface control configured to receive a discrete value from a second input device, the second input device configured to transmit the discrete value; receive the discrete value from the second input device; and cause automatic control of the controllable item to adjust the controllable attribute of the controllable item from a current value to the discrete value based on receiving the discrete value.

The following detailed description and accompanying drawings provide a more detailed understanding of the nature and advantages of the present invention.

### BRIEF DESCRIPTION OF THE DRAWINGS

FIG. 1 depicts a simplified system for providing item control according to one embodiment.

FIG. 2 depicts a simplified flowchart for applying discrete values to controllable attributes according to one embodiment.

FIG. 3 depicts a simplified flowchart of a method for processing discrete values according to one embodiment.

FIG. 4 depicts a more detailed example of a computing device according to one embodiment.

FIG. 5 depicts an example of a control point according to one embodiment.

FIG. 6 depicts an example of a controllable item according to one embodiment.

FIG. 7 depicts a simplified flowchart for determining if a discrete value is a valid input according to one embodiment.

FIG. 8 depicts a more detailed example of an interface according to one embodiment.

### DETAILED DESCRIPTION

Described herein are techniques for a system to control controllable items using discrete input. In the following description, for purposes of explanation, numerous examples and specific details are set forth in order to provide a thorough understanding of embodiments of the present invention. Particular embodiments as defined by the claims may include some or all of the features in these examples alone or in combination with other features described below, and may further include modifications and equivalents of the features and concepts described herein.

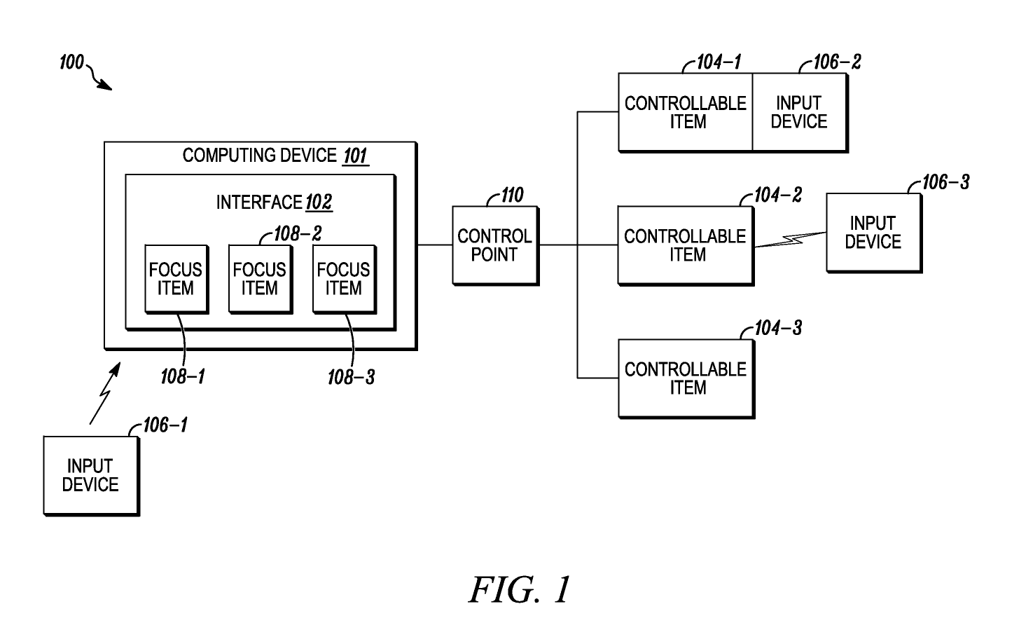

FIG. 1 depicts a simplified system 100 for providing item control according to one embodiment. A computing device 101 includes an interface 102 that is used to control controllable items 104 based on input from an input device 106-1.

Focus items 108 may be associated with various controllable items 104. For example, focus item 108-1 is associated with controllable item 104-1; focus item 108-2 is associated with controllable item 104-2; and focus item 108-3 is associated with controllable item 104-3. Focus items 108 may visually indicate which controllable items 104 they are associated with, such as an icon for focus item 108-1 may show a picture of a thermostat such that a user can recognize that focus item 108-1 is associated with a physical thermostat.

Controllable items 104 may be any devices that are physical or virtual. For example, physical items may include thermostats, lights, locks, and other devices that may be found in a location, such as a user's home. Examples of virtual items include applications, content, music, and content feeds.

Controllable attributes may be aspects of controllable items 104 that can be automatically controlled. For example, interface 102 may be used to control controllable items 104. When an input is received at computing device 101, computing device 101 automatically controls controllable item 104. For example, a temperature on a thermostat may be set using interface 102.

Input device 106-1 may be any device that can be used to send signals to computing device 101. For example, input device 106-1 may include a remote control, a cellular phone, a laptop computer, or a tablet computer. In one embodiment, input device 106-1 may include a discrete value input control on which discrete values can be input. For example, a discrete value input control may be a keypad. Other methods may also be used to input discrete values, such as using a voice control to input the discrete value. Input device 106-1 can send the discrete values to computing device 101. Discrete values may be values that have a limited number of values within a range where the discrete value input control can be used to input any of the discrete values without a constraint of inputting consecutive incremental values.

Controllable items 104 may be associated with input devices 106-2. In one embodiment, input devices 106-2 are designed to operate only with a specific controllable item 104. Input devices 106-2 apply the input to controllable items 104 in incremental values. For example, input devices 106-2 may include incremental value input controls that increase or decrease a value for a controllable attribute one consecutive increment at a time. The incremental value input controls include slider bars, scroll wheels, and arrow keys. The incremental value input controls cannot jump between two non-contiguous values. For example, if brightness of a lamp can be controlled between 0% and 100%, a current brightness is 60%, and the incremental value is 1%, input device 106-2 can only increment the brightness from 60% to 61% or decrement the brightness from 60% to 59% with one input.

In one embodiment, input device 106-2 may be integrated with controllable item 104-1. For example, input device 106-2 may not be detachable from controllable item 104-1. In other examples, input device 106-2 may be a remote control that can send signals to controllable item 104-2. In this case, space may be limited for input device 106-2 on the surface of controllable item 104-1 or less functionality is desired. Also, in one embodiment, a discrete value input control is not included on input device 106-2 such that input device 106-2 cannot be used to input discrete values. When a change to the value of a controllable attribute is performed using input device 106-2, the controllable attribute value is changed in consecutive increments. For example, if brightness is changed from a 50% level to a 60% level, a user would input the increased value ten times if the incremental value is 1%. Thus, ten inputs are received to change brightness from 50% to 60%. In one embodiment, each input increasing the brightness by 1% is applied to the lamp. Thus, the brightness is changed ten times.

In some cases, controllable items 104 may be able to receive a discrete value for controlling a controllable attribute even though input device 106-2 only controls the controllable attribute in incremental values. For example, a controller in controllable item 104 may be able to receive a discrete value and use the discrete value to control the controllable attribute. Particular embodiments leverage the use of input device 106-1 to allow a discrete value received from a discrete value input control on input device 106-1 to be used to control controllable item 104. For example, a control point 110 may be leveraged to send the discrete value to controllable item 104. The controllable attribute is then automatically adjusted from a current value to the discrete value by controllable item 104. The discrete value may not be a consecutive incremental value from the current value. For example, if the current value is 50, the discrete value may be 60. Thus, a number of inputs required to increase or decrease a value for the controllable attribute is reduced by allowing the use of discrete values.

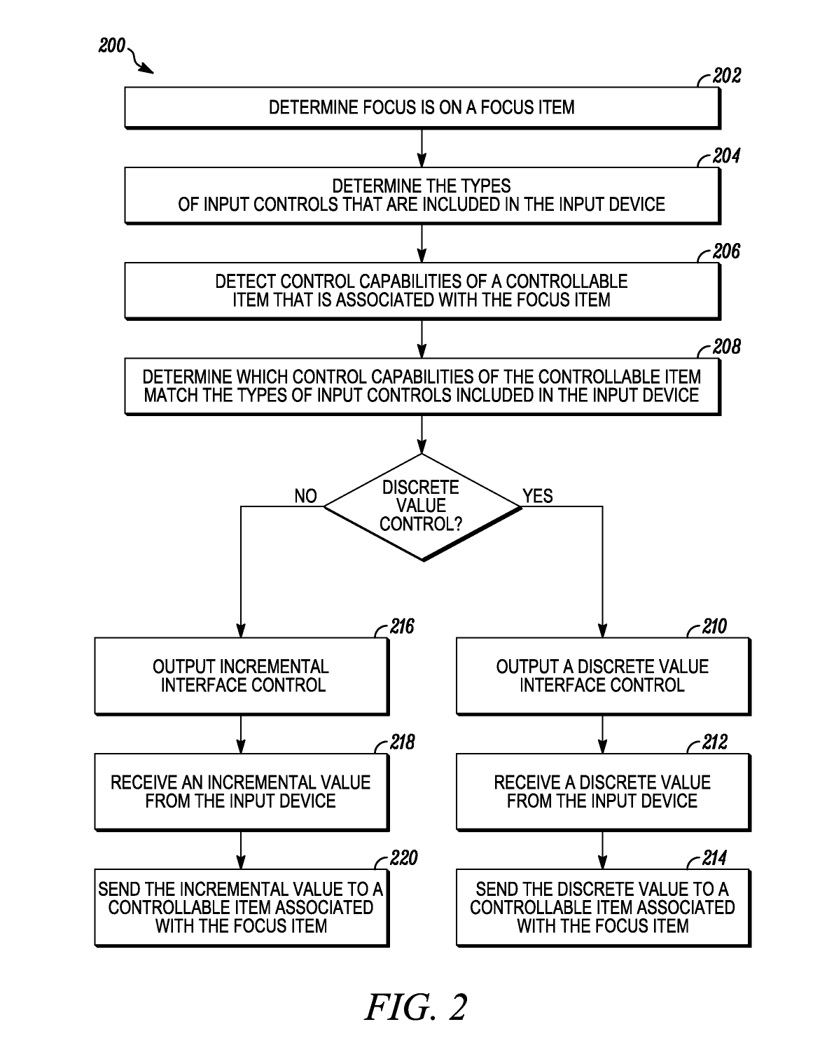

FIG. 2 depicts a simplified flowchart 200 for applying discrete values to controllable attributes according to one embodiment. At 202, computing device 101 determines focus is on a focus item 108. Particular embodiments determine focus on a focus item 108. The focus on focus item 108 may be determined using various indications. For example, the focus may be determined from objects, controls, display or screen areas, or other items, to which a user has directed his/her attention to focus item 108. Focus can be determined or assumed based on detecting that a user's attention is directed towards, or has changed to, a focus item 108. For example, focus can occur when a pointer rollover (i.e., mouse-over) on focus item 108 occurs, and a pointer sufficiently close to focus item 108, or when a user actually selects (e.g., clicks on) focus item 108. Additionally, a user may navigate to focus item 108 using keystrokes to select focus item 108. For example, a user may move a box to highlight focus item 108 and then select focus item 108 using an “enter” key on input device 106. If a touch screen is used, focus may be determined by a user touching the area on/around focus item 108.

Also, the focus may be determined in other ways, such as focus is determined based on an external event that occurs. For example, input device 106 may be pointed at controllable items 104 themselves. Optical recognition or codes may be used to determine which controllable item 104 is being focused on by input device 106. Also, when a temperature goes above a certain degree threshold, the focus may automatically change to a thermostat.

At 204, computing device 101 may determine the types of input controls that are included in input device 106-1. One type of control may be a discrete value input control and another type of input control may be an incremental value input control. In one example, computing device 101 may query input device 106-1 for the types of controls. Also, an identifier for input device 106-1 may be determined and used to determine which input controls input device 106-1 includes from different listings of input devices and the types of input controls supported.

At 206, computing device 101 detects control capabilities of a controllable item 104 that is associated with focus item 108. The control capabilities include the ability to receive discrete values or incremental values as input. In some cases, controllable item 104 may be able to receive both incremental values and discrete values. Also, input device 106-2 associated with controllable item 104 may not be able to provide discrete values to controllable item 104, but controllable item 104 can nevertheless receive discrete values.

At 208, computing device 101 determines which control capabilities of controllable item 104 match the types of input controls included in input device 106-1. The types of controls that match control capabilities may then be output on interface 102. In other embodiments, the types of input controls of input device 106-1 and the control capabilities of controllable item 104 may not be compared. Rather, both incremental interface controls and discrete value controls may be output on interface 102 by default if controllable item 104 can receive both types of inputs.

At 210, if one of the matching types of input controls is a discrete value control is included, then computing device 101 adds a discrete value interface control to interface 102. In some embodiments, an incremental interface control and a discrete value interface control may always be added irrespective of the types of controls included in input device 106-1. Thus, when an input device 106-1 is used that can input discrete values, the interface control is available to receive the discrete values.

At 212, computing device 101 receives a discrete value from input device 106-1. For example, a user may enter in a discrete numeric value into input device 106-1. This discrete numeric value is then sent to computing device 101.

At 214, computing device 101 sends the discrete value to a controllable item 104 that is associated with focus item 108. For example, computing device 101 may send the discrete value to control point 110. Control point 110 may then route the discrete value to controllable item 104.

At 216, if one of the matching types of controls is an incremental input, an incremental interface control is output on interface 102. This allows incremental input to be received from input device 106-1.

At 218, computing device 101 receives an incremental value from input device 106-1. For example, a user may enter in a series of incremental values into input device 106-1. The incremental values are then sent to computing device 101.

At 220, computing device 101 sends the incremental value to a controllable item 104 that is associated with focus item 108. For example, computing device 101 may send the series of incremental values to control point 110. Control point 110 may then route the series of incremental values to controllable item 104.

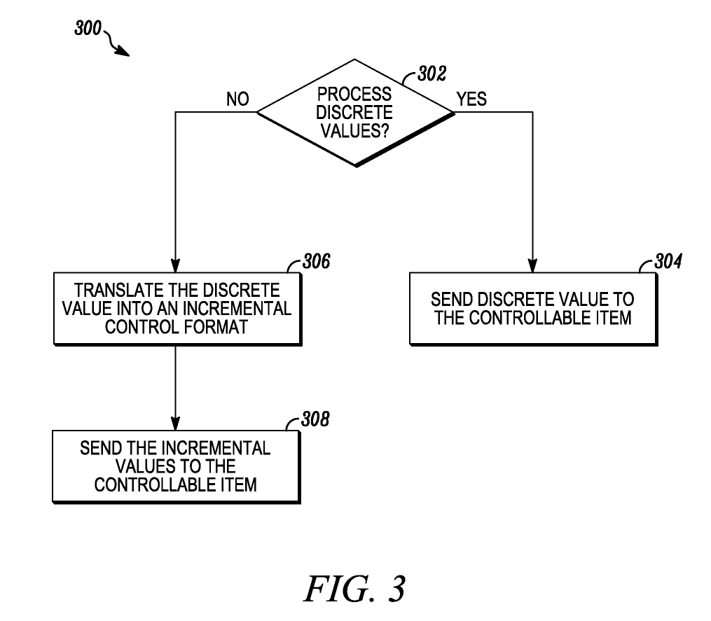

Controllable item 104 may be able to receive discrete values for controllable attributes. However, in some cases, the discrete values received from input device 106-1 may need to be translated into a different format to be applied to the controllable attribute of controllable item 104. FIG. 3 depicts a simplified flowchart 300 of a method for processing discrete values according to one embodiment. The method may be performed by computing device 101, control point 110, controllable item 104, or any combination thereof.

At 302, the method determines if controllable item 104 can process discrete values. This determination may be made at computing device 101 and/or control point 110. At 304, if a discrete value can be processed, the discrete value is sent to controllable item 104.

At 306, if a discrete value cannot be processed by controllable item 104, then the discrete value may be translated into a format controllable item 104 can process, such as the discrete value is translated into an incremental control format where incremental control values may be sent to controllable item 104 to cause controllable item 104 to change the controllable attribute to the discrete value. In one example, if a brightness value is increased from 50% to 60% by receiving a 60% value from input device 106-1, then 10 incremental value inputs are sent to controllable item 104 to increase the brightness level to 60%. This automatically increases the brightness level to the discrete value without requiring a user to place ten incremental inputs.

At 308, incremental values are sent to controllable item 104. For example, a series of incremental values are sent.

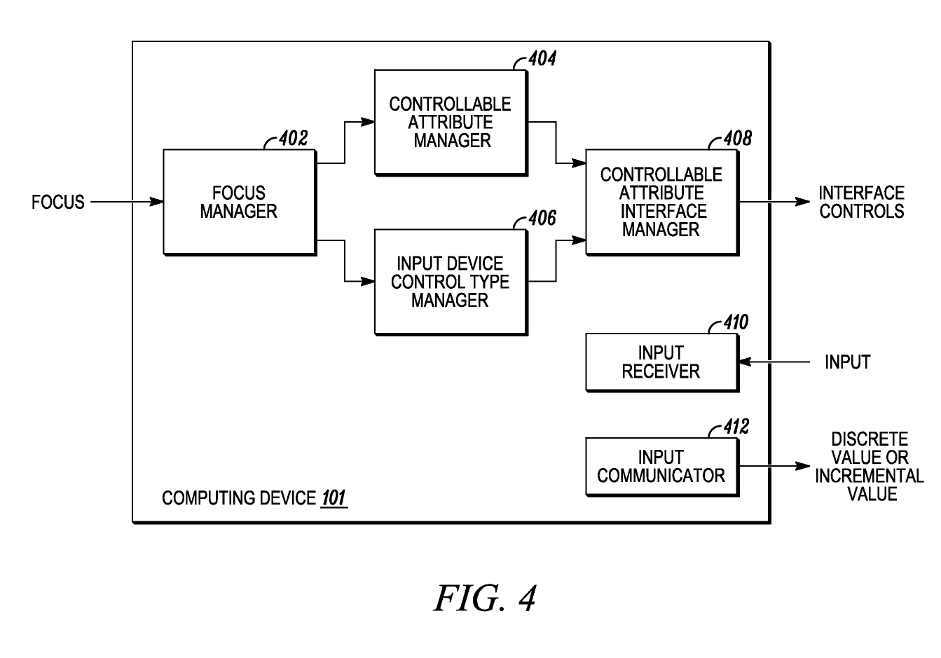

FIG. 4 depicts a more detailed example of computing device 101 according to one embodiment. A focus manager 402 is configured to determine focus on focus items 108. A focus manager 302 detects when focus is on a focus item 108. For example, user input may be received from input device 106 and focus manager 302 determines when focus is on a specific focus item 108. In other examples, events may be received by focus manager 302 and are used to determine when focus is on a focus item 108. For example, input device 106 may be pointed at a physical item.

A controllable attribute manager 404 determines control capabilities for controllable attributes for a controllable item 104 associated with a selected focus item 108. For example, a list in a database may be used to determine various control capabilities for different controllable attributes for each controllable item 104. Also, an input device control type manager 406 detects the type of input controls included in input device 106-1.

A controllable attribute interface manager 408 determines which interface controls to output to interface 102. For example, the types of input controls are compared with control capabilities for a selected controllable attribute for focus item 108. The types of input controls that match may then be output on interface 102. For example, if a numeric keypad is included in an input device 106-1 and a controllable attribute is able to receive discrete values, then an interface control to receive discrete values may be output on interface 102.

An input receiver 410 receives input from input device 106-1. For example, the input may be incremental values or a discrete value. An input communicator 412 then transmits the incremental values or discrete value to a controllable item 104 associated with focus item 108. As was described above, translation of a discrete value may be performed. For example, a discrete value may be translated into incremental inputs. Also, the translation may be performed by control point 110.

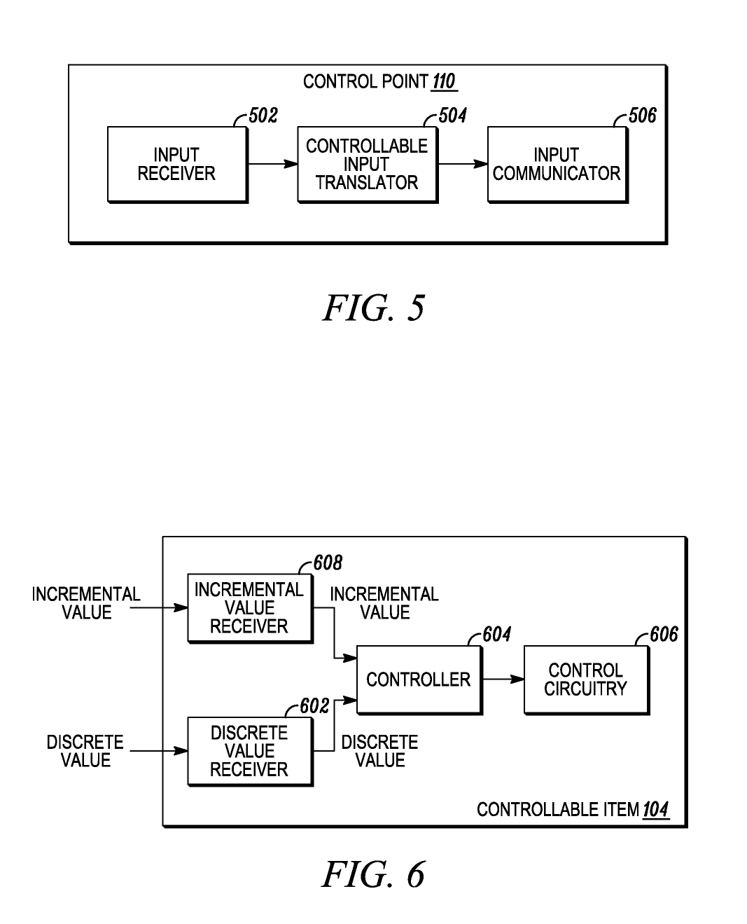

FIG. 5 depicts an example of control point 110 according to one embodiment. An input receiver 502 receives an input from computing device 101. For example, a discrete value may be received at input receiver 502.

In one embodiment, a controllable input translator 504 may translate the input received. In other embodiments, computing device 101 may perform the translation. Controllable input translator 504 may determine if controllable item 104 can receive a discrete value or not. The translation may then be performed if controllable item 104 cannot receive and process the discrete value. An input communicator 506 then sends the input in a form that can be processed by controllable item 104.

FIG. 6 depicts an example of controllable item 104 according to one embodiment. An incremental value receiver 608 receives incremental input from input device 106-2. Controllable item 104 may include a controller 604 that applies the incremental input to control circuitry 606. Each incremental input is applied to control circuitry 606 to adjust the controllable attribute. Incremental value receiver 608 provides an interface to allow for incremental value input to be received from input device 106-2. Also, in the example, where incremental inputs are translated from a discrete value, then incremental value receiver 608 receives and processes the incremental values.

In some cases, controller 604 can process input in discrete values. A discrete value receiver 602 leverages the ability of controller 604 to process discrete values. For example, discrete value receiver 602 receives the discrete value and then sends it to controller 604. The discrete value is then applied to control circuitry 606 to control controllable item 104.

In some cases, the effect of applying the discrete value may cause the controllable item to jump to that discrete value. For example, a thermostat may jump from 60° F. to 80° F. In other cases, the controllable attribute may be controlled in incremental values. For example, based on one input of a discrete value of 60%, a lamp brightness is incrementally increased from 50% to 60% in 1% increments. Because controller 604 is able to receive incremental input and also discrete values, a different input device 106-1 with a discrete value input control can be leveraged to apply the discrete value to controllable item 104.

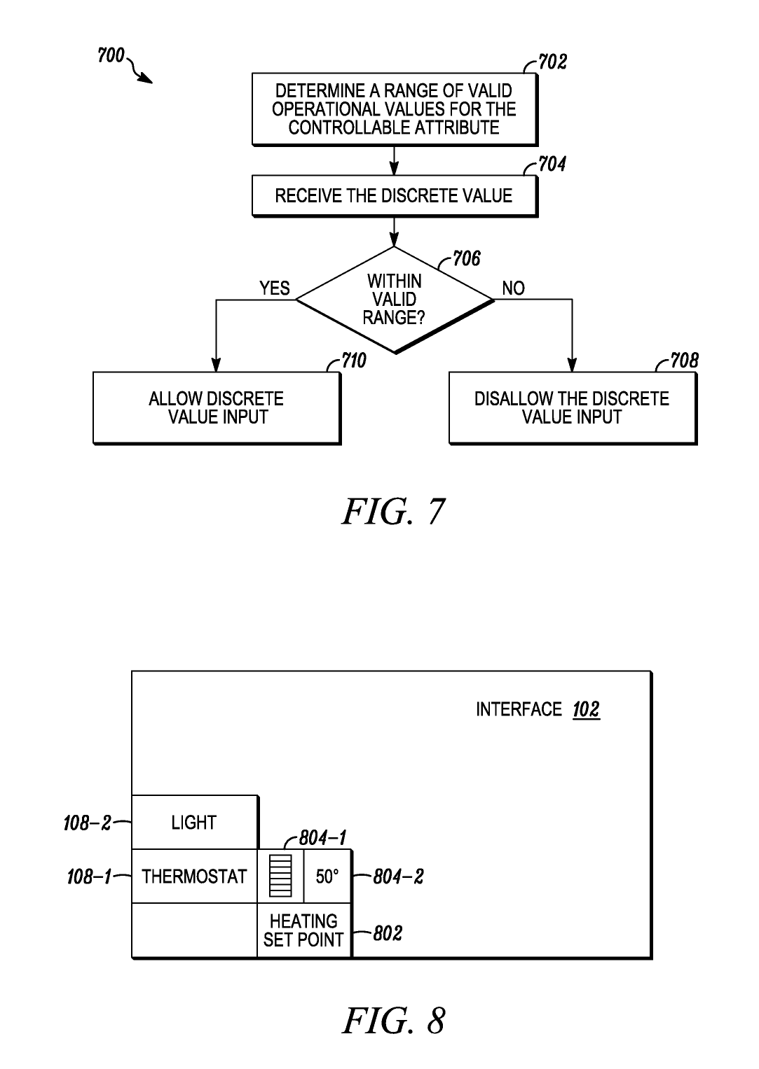

Because a user may enter in any random discrete value, it is possible that the discrete value may not be within a working range allowed for a controllable attribute. FIG. 7 depicts a simplified flowchart 700 for determining if a discrete value is a valid input according to one embodiment. At 702, computing device 101 determines a range of valid operational values for the controllable attribute. For example, a brightness level for a lamp may be available from 0% to 100%. Also, the thermostat may be set between a temperature of 20° F.-80° F.

At 704, computing device 101 receives the discrete value. At 706, computing device 101 determines if the discrete value is within the range of valid operational values. If the discrete value is outside of the range, at 708, computing device 101 disallows the discrete value input. In this case, the user may be prompted to input another discrete value. In another embodiment, computing device 101 may automatically change the discrete value input to a value within the range. At 710, if the discrete value is within the range, then the input is allowed.

FIG. 8 depicts a more detailed example of interface 102 according to one embodiment. As shown, a focus item 108-1 corresponds to a thermostat and a focus item 108-2 corresponds to a light. Focus has been detected on the thermostat. In this case, the user may automatically control the thermostat. A controllable attribute is shown in a display position 802. In this case, a heating set point may be controlled using input device 106-1. An incremental interface control 804-1 allows for an incremental input to be used. For example, a bar showing a temperature level may be increased or decreased by incremental levels. Also, a discrete value interface control 804-2 allows a user to enter in a discrete value. For example, the user may enter in an exact temperature using a numeric keypad. For example, the current heating set point is set at 50° F. The user may change the heating set point to 60° F. In this case, the numeric value of “60” may be received from input device 106-1.

Accordingly, particular embodiments allow a user to leverage additional input control types from input device 106-1 that may not be available on input device 106-2. The ability of controllable item 104 to process discrete values even though input device 106-2 does not have the capability for inputting discrete values is leveraged to allow discrete values to be input. Thus, convenience for setting discrete values for controllable attributes is provided.

Particular embodiments may be implemented in a non-transitory computer-readable storage medium for use by or in connection with the instruction execution system, apparatus, system, or machine. The computer-readable storage medium contains instructions for controlling a computer system to perform a method described by particular embodiments. The instructions, when executed by one or more computer processors, may be operable to perform that which is described in particular embodiments.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents may be employed without departing from the scope of the invention as defined by the claims.

What is claimed is:

1. A method comprising:
determining focus on a focus item associated with a controllable item, the focus item being displayed on an interface used to automatically control the controllable item;
determining a controllable attribute for controlling the controllable item, the controllable attribute being controllable by a first input device using incremental inputs;
outputting, by a computing device, an interface control on the interface for the controllable attribute, the interface control configured to receive a discrete value from a second input device, the second input device configured to transmit the discrete value;
receiving the discrete value from the second input device; and
causing automatic control of the controllable item to adjust the controllable attribute of the controllable item from a current value to the discrete value based on receiving the discrete value.

2. The method of claim 1, wherein the discrete value is a numeric value.

3. The method of claim 1, wherein:
the discrete value is received from a discrete value input control included in the second input device, and
the first input device does not include the discrete value input control for inputting the discrete value.

4. The method of claim 1, wherein:
the controllable item cannot process an input of the discrete value, and
the discrete value is translated into a corresponding plurality of incremental inputs based on the current value.

5. The method of claim 1, wherein the discrete value is sent to a control point configured to control the controllable item using the discrete value.

6. The method of claim 1, wherein:
the first input device is configured to adjust the controllable attribute of the controllable item in consecutive incremental values requiring incremental inputs for each incremental value, and
the discrete value is a value that is not a consecutive incremental value from the current value.

7. The method of claim 1, further comprising:
determining a range of operational values for the controllable attribute;
determining if the discrete value is within the range; and
not adjusting the controllable item if the discrete value is not within the range.

8. The method of claim 1, further comprising:
determining types of input controls included in the second input device;
determining if the types of input controls include an input control to input discrete values; and
if the types of input controls include an input control to input discrete values, adding the interface control on the interface to allow the controllable attribute to be controlled using the discrete values.

9. The method of claim 8, further comprising:
determining control capabilities of the controllable attribute;
comparing the control capabilities to the types of input controls; and
outputting interface controls for the type of input controls that match the control capabilities.

10. The method of claim 8, further comprising:
determining if the types of input controls include an input control to input incremental values; and
if the types of input controls include an input control to input incremental values, adding an incremental value interface control on the interface to allow the controllable attribute to be controlled using incremental values.

11. A non-transitory computer-readable storage medium containing instructions for controlling a computer system to be operable to:
determine focus on a focus item associated with a controllable item, the focus item being displayed on an interface used to automatically control the controllable item;
determine a controllable attribute for controlling the controllable item, the controllable attribute being controllable by a first input device using incremental inputs;
output an interface control on the interface for the controllable attribute, the interface control configured to receive a discrete value from a second input device, the second input device configured to transmit the discrete value;
receive the discrete value from the second input device; and
cause automatic control of the controllable item to adjust the controllable attribute of the controllable item from a current value to the discrete value based on receiving the discrete value.

12. The non-transitory computer-readable storage medium of claim 11, wherein the discrete value is a numeric value.

13. The non-transitory computer-readable storage medium of claim 11, wherein:
the discrete value is received from a discrete value input control included in the second input device, and
the first input device does not include the discrete value input control for inputting the discrete value.

14. The non-transitory computer-readable storage medium of claim 11, wherein:
the controllable item cannot process an input of the discrete value, and
the discrete value is translated into a corresponding plurality of incremental inputs based on the current value.

15. The non-transitory computer-readable storage medium of claim 11, wherein:
the first input device is configured to adjust the controllable attribute of the controllable item in consecutive incremental values requiring incremental inputs for each incremental value, and
the discrete value is a value that is not a consecutive incremental value from the current value.

16. The non-transitory computer-readable storage medium of claim 11, further operable to:
determine a range of operational values for the controllable attribute;
determine if the discrete value is within the range; and
not adjust the controllable item if the discrete value is not within the range.

17. The non-transitory computer-readable storage medium of claim 11, further operable to:
determine types of input controls included in the second input device;
determine if the types of input controls include an input control to input discrete values; and
if the types of input controls include an input control to input discrete values, add the interface control on the interface to allow the controllable attribute to be controlled using the discrete values.

18. The non-transitory computer-readable storage medium of claim 17, further operable to:
determine control capabilities of the controllable attribute;
compare the control capabilities to the types of input controls; and
output interface controls for the type of input controls that match the control capabilities.

19. The non-transitory computer-readable storage medium of claim 17, further operable to:
determine if the types of input controls include an input control to input incremental values; and
if the types of input controls include an input control to input incremental values, add an incremental value interface control on the interface to allow the controllable attribute to be controlled using incremental values.

20. An apparatus comprising:
one or more computer processors; and
a computer-readable storage medium comprising instructions for controlling the one or more computer processors to be operable to:
determine focus on a focus item associated with a controllable item, the focus item being displayed on an interface used to automatically control the controllable item;
determine a controllable attribute for controlling the controllable item, the controllable attribute being controllable by a first input device using incremental inputs;
output an interface control on the interface for the controllable attribute, the interface control configured to receive a discrete value from a second input device, the second input device configured to transmit the discrete value;
receive the discrete value from the second input device; and
cause automatic control of the controllable item to adjust the controllable attribute of the controllable item from a current value to the discrete value based on receiving the discrete value.
